(19) United States
(12) Patent Application Publication
(10) Pub. No.: US 2025/0307966 A1
(43) Pub. Date: Oct. 2, 2025

(54) A MULTIDISCIPLINARY EDUCATION SYSTEM AND AN ORGANIZATION METHOD SUITABLE FOR THIS SYSTEM

(71) Applicants: Sadik Berkehan SARPAS, Kadiköy- Istanbul (TR); Sarpas Danismanlik A.S., Kadiköy- Istanbul (TR)

(72) Inventor: Sadik Berkehan SARPAS, Kadiköy- Istanbul (TR)

(21) Appl. No.: 18/864,587

(22) PCT Filed: Jul. 10, 2023
(86) PCT No.: PCT/TR2023/050670

§ 371 Date: Nov. 11, 2024

(30) Foreign Application Priority Data
May 9, 2022 (TR) 2022/007485
May 9, 2023 (TR) 2023/005155

(51) Int. Cl. G06Q 50/20

(52) U.S. Cl. CPC G06Q 50/20

(57) ABSTRACT

The present invention is related to a controlled system that supports different thinking skills of the user (300) with a multi-disciplinary resource (402, 502, 602, 702), equipment, and applications (403, 503, 603, 703), enables their competences (306) to come out in accordance with the field of interests (304), allows them to detect the life purpose interface (301), allows said interface (301) to coincide with social problems (400), allows them to gain by combining with commercial benefit (profit) (401), produces compositions depending on the content (402) created by the inventor, and depending on them, enables the user to think as a polymath according to the new world order, analyze, take action and through new interfaces (400, 500, 600, 700) improve projects (800) or business sets (801) which create difference and value, as well as an organization method developed according to said system.

### TECHNICAL FIELD

The present invention relates to a controlled education system and a suitable organization method that enables the user (300) to identify the purpose-of-life interface (301), which supports different thinking skills with multidisciplinary resources (402, 502, 602, 702), equipment and practices (403, 503, 603, 703), allows the competencies (306) to be revealed in line with the interests (304), allows this interface (301) to be intersected with social problems (400), allows it to gain by combining it with commercial benefit (profit) (401), produces compositions depending on the content (402) created by the inventor and, accordingly, allows the user to think, analyse, take action and develop projects (800) or work sets (801) that create difference and value with the help of new interfaces (400, 500, 600, 700).

### STATE OF THE ART

The present invention relates to a system and method supporting this system that enables the user to gain a wide perspective (900), acquire different thinking skills (305) and increase their intellectual level with a universally developed interdisciplinary education model within the education sector, whose target audience is predominantly entrepreneurs, and that allows them to transform into serial entrepreneurs (802) who can produce work sets (801) in-house or freely and sustainably combat social problems.

There are various sources, materials and practices in different units of the education sector and they are reproduced to serve the purpose of education. These said resources mostly serve in a written, written-applied or only practically desirable manner on a single field vertical. It allows privatization or progress in a single area. Accordingly, uniform systems emerge and cannot meet the need.

However, in the rapidly changing and developing world order, there is a need for models that allow people (users) (300) to realize their life purpose (301), to create visions in a wide sense, to teach them to fight without compromising their adopted goals and values, to adopt a solution-oriented approach to problems, and to benefit from different multidisciplinary resources whose features are designed (100, 200) to the finest detail, thus encouraging creativity and simultaneously internalizing them in all aspects.

From the wars in the first half of the twentieth century to the present day, the world's population has increased very rapidly and nearly tripled, leading to an increase in social problems. Problems such as global warming, migration and epidemic have increased and the problems it creates have increased day by day. In addition, thanks to developing technologies, the world has become more aware of these problems day by day.

In this rapidly changing new world order, it is becoming quite inadequate to continue with the solutions of systems that emerge by chance. However, every serial user (entrepreneur) who creates work sets or project outputs is expected to be more sensitive to the problems mentioned and to produce solutions that meet the needs. It is expected that solution-oriented users (entrepreneurs) who focus on life, blend commercial profit with purpose, and are competent to take risks for unfamiliar parties will take responsibility. Therefore, systems that prepare work sets or project outputs to adapt to the new order or to be solution-oriented users of the new order are becoming important.

In the new world order, serial users who develop solution-oriented methods to the problems mentioned, who can make commercial profits while producing solutions that can be applied to the industry to these problems, and who can use the commercial profits obtained to improve the world with solutions instead of expanding their comfort area are becoming important. When evaluated in this respect, it is necessary to design the systems that prepare the users (entrepreneurs) for these competence levels with great care and different methods.

On the other hand, entrepreneurship centres and systems that operate worldwide today mostly focus on projects, not people. The general approach of these systems is based on trying to grow and market the entrepreneur's project quickly with some general education and consultancy systems and to multiply the capital by bringing these projects together with the investor as soon as possible. However, in project output and work sets, the sustainability of life for the entrepreneurial user comes before capital.

On the other hand, in the new economic orders, users (teams) with high mental resilience who evaluate and direct these resources in the most accurate way, instead of business ideas or business models, are at the basis of the rapid growth stories of their huge initiatives. The common feature of these serial users, who produce work sets that make the world more livable, is that they are at a more mature level than the average person. Entrepreneurial users who have not reached a certain level of maturity in terms of personality criteria and technique do not have projects that will change the world (projects that make the world more livable).

Discipline and self-control skills have a very important place in education models, especially in systems that address entrepreneurship. It is quite inadequate because it does not prioritize the transformation of users (entrepreneurs) into self-managed individuals to add purely technical knowledge to other entrepreneurship programs that are already in place. The concept, which addresses the military discipline model in the interfaces that make up our present invention, contributes to the transformation of users (entrepreneurs) into competent and disciplined users with its methodology and interface practices.

Users (entrepreneurs) can grow their business by establishing strong teams (community of serial users) in addition to the education systems they receive. The level of trust in the established teams brings success. However, when the users (entrepreneurs) who meet randomly in this field establish cooperation without knowing each other well and without going through a similar model system, their business efficiency decreases as a result of the disputes that arise. Targeted work sets and project outputs end before they can provide the desired solutions. In the system developed as a solution to these and similar problems in existing systems (GIS interfaces), high trust and cooperation are established between users (entrepreneurs) who have fulfilled certain conditions and high standards in the developed method, in other words, who have completed the interfaces, and thus, projects with higher competence emerge from the teams that accelerate cooperation and are better organized.

In the present invention, users are primarily involved in a very special and unusual training process. In this process, they redefine themselves and life, increase their awareness, gain mental resilience, expand their visions, increase their wisdom levels and bring all technical and theoretical knowledge equipment to a complete level. They can establish their own business in the plainest form before the end of the training. Thus, it has a strong foundation on which they can create work sets. Then, those who are successful in the program are taken to the graduate user community to come together with other graduates who can speak the same language and share the same values, and they are supported here for life in an organized way.

Today, some methods allow the user (300) to develop and include different types of practices. Since each of them consists of separate training or practices, users often cannot obtain all of them at the same time, and since they cannot obtain the training at the same time, the existing training is insufficient and the users cannot create the desired effect. In some cases, inefficiency arises due to the inadequacy of the training content.

One of the other issues that are missing in interdisciplinary education models is the mentor support interface (302) consisting of experts in their field. The lack of this interface makes it difficult to create or use features such as wisdom (306, 307), merit (worthiness) (306, 307), fairness (306, 307), altruism (306, 307), teamwork (306, 307), transparency (306, 307), mental (306, 307, 308), and physical resilience (306, 307), entrepreneurship (306, 307), serial entrepreneurship (802), solution-oriented thinking (309). It prevents the development of solution-oriented and creative thinking structures (309) by establishing relationships with different sources.

In the education world, the strength of the mind structure (mental resilience) (308) is as important as knowledge. Today, the training methods currently used do not include interfaces that will improve mental resilience (308), determination, passion and strength of the mind structure. The lack of these interfaces decreases the efficiency in the implementation of other training. In the method developed by the present invention, these techniques are introduced to the users by various practices (403, 503, 603, 703).

Another important issue in the world of education is that the multidisciplinary information transferred is put into practice physically and thus internalized in a short time. The system or the methods used in the current art only have a knowledge-based structure. Educations that develop, change or allow the development of physical or mental criteria and abilities are limited. In the system (200) we have developed, some methods allow this situation.

Another inadequate point in the system or methods currently used in the education world is the lack of interfaces (400, 500, 600, 700) that allow users to recognize the structure of the brain (310) and the way the brain works (311), improve the structure of thinking and allow it to overcome inertia. In educational methods where these functions are not available at the same time or any of them are insufficient, projects or initiatives (800, 801) that create difference and value (403, 404) cannot be developed and cannot provide long-term progress even if they are developed.

Some of the practices used are dietary habits that address the military order system and directly affect many points in the user's life. Training related to these interfaces (400, 500, 600, 700), which directly affects the life order, aims to improve the quality of life (312) by increasing the efficiency of the user, and to create effective projects.

As a result, due to the disadvantages described above and the lack of available solutions in this regard, it was necessary to make improvements in the relevant technical field. Due to the disadvantages explained above and the lack or insufficient solutions in this regard, it has become necessary to develop new methods and systems in the relevant technical field.

### TECHNICAL PROBLEMS TO BE SOLVED BY THE INVENTION

The system developed by the present invention and the method created in this system aim to eliminate the aforementioned negativities in the currently ongoing practices.

The main object of the invention is to implement a controlled system (200) and a method developed in accordance with this system that enables the user (100) to think, analyse, take action and develop projects (403, 404, 801, 802) that create difference and value with the help of new interfaces (400, 500, 600, 700), that support different thinking skills with multidisciplinary resources, equipment and practices, that enable their competencies to be revealed in line with their interests, that produce compositions depending on the content created by the inventor, and that are compatible with the new world order.

The system developed by the present invention and the method created in this system aims to develop a method that allows users (100) to have high mental resilience (307, 308) and to develop features such as wisdom (307, 308), merit (worthiness) (307, 308), being fair (307, 308), altruism (307, 308), teamwork (307, 308), transparency (307, 308), mental (307, 308), and physical resilience (307, 308), entrepreneurship, serial entrepreneurship (802), solution-oriented thinking (309).

In the system developed with the present invention and the method created in this system, it is aimed to create projects or initiatives that are far from uniformity, produce solutions to social problems, and create difference and value. In this context, the system allows users to realize their unique life goals, associate these goals with both a social problem and commercial profit and write a manifesto, to prepare the ground for the user to produce step-by-step project outputs and work sets in the process, to eliminate those whose competence is not appropriate with various tests, and to ensure the development of dynamic cooperation between those who have reached the graduate user status.

In the system developed with the present invention and the method created in this system, it is aimed to continue the projects or initiatives that are revealed with the environment prepared for the user for a long time and to position them on a global scale.

The system developed by the present invention and the method created in this system aim to specialize in entrepreneurship from horizontal to vertical, that is, from general to specific, simultaneously with the practices.

In the system developed by the present invention and the method created in this system, it is aimed to make progress in a regular and unbiased manner in groups, that is, in teams formed with different users.

In the system developed with the present invention and the method created in this system, it is aimed to develop solution-oriented thinking structures (309) by establishing relations with different sources and disciplines by the users (100).

In the system developed with the present invention and in the method created in this system, the discipline concept model in the military order is also discussed in the practices in the interfaces. In this way, it contributes to the transformation of users (entrepreneurs) into more systematic and skilled (disciplined) users with methodology and system interface practices.

In the system developed with the present invention and in the method created in this system, it is aimed to increase the intellectuality level and vision of the users by associating entrepreneurship with the subjects such as quantum physics and genetics, which constitute the systems from today to the future in an interdisciplinary approach with the model developed by supporting different ways of thinking and behaviour with source practice materials.

In the system developed with the present invention and the method created in this system, in the rapidly changing and developing new world order, it is aimed to transform a user (300) who adopts a solution-oriented understanding of the problems that enable the person to know their life purpose and allows mental resilience, emotional flexibility and topological thought structure down to the finest details into a serial user (802).

### FIGURES FOR THE DESCRIPTION OF THE INVENTION

FIG. 1. The questionnaire that makes up the database

FIG. 2. Algorithm index where the preliminary evaluation system is located

FIG. 3.a GIS Adaptation questionnaire

FIG. 3.b Schematizing the GIS Adaptation interface

FIG. 4a. GIS boot camp unit questionnaire

FIG. 4b. The schematization of the GIS boot camp unit interface

FIG. 5.a GIS Infantry (master) camp unit questionnaire

FIG. 5.b Schematizing the GIS Infantry (master) camp unit interface

FIG. 6. Goals index

FIG. 7. Profile characterized as a serial user

FIG. 8. User model characterized as GIS type

FIG. 9. Fair sales figure algorithm characterized as commercial benefit

FIG. 10. Other

FIG. 11. Other

FIG. 12. Other

FIG. 13: Transformation of the user into a serial user

FIG. 14. Schematizing the UGGS unit interface

FIG. 15. Schematizing the GIA unit interface

FIG. 16. Schematizing the system entirely

### DESCRIPTION OF THE REFERENCES

100. Database
101. A system that keeps this form in the database, enabling users to fill out forms on the website
102. A system that scores forms according to a previously trained statistical model
103. A system that transfers the forms to the evaluation system with API access, queries the evaluation result with API access and transmits the predefined action from the incoming score to the person management and e-mail software with API access.
104. An e-mail system that unsubscribes the person from the list
105. Person management system where personal information is kept and profiles accepted for preliminary evaluation are added to the required departments
106. If the evaluated forms are below a certain percentage of similarity to the model, the system that transmits the form to the department required for human evaluation
107. Time-sensitivity
108. Interface demonstrating the consistency of the communication skills
200. Platform (system)
201. Platform questionnaire
202. Platform database
203. Server
204. Server database
205. Banned (blocked) user
300. User
301. Life purpose interface (database)
302. Mentor support interface (database)
303. Web interface
304. User interests
305. Interface characterized as a polymath
306. Competencies existing in the user
307 Competencies acquired by the user in the method
308. Competency defined as mental resilience
309. Interface characterized as a solution-oriented mindset
310. User brain structure knowledge pool
311. Information system on the functioning of the user's brain
312. Interface defining user quality of life
313. Wide perspective interface
400. Interface that defines social problems
401. Interface characterized as commercial benefit
402. Content created by the invention holder
403. The interface that allows making a difference
404. The interface that allows creating value
500. GIS Adaptation interface (database)
501. GIS Adaptation questionnaire
502. GIS Adaptation resources
503. GIS Adaptation practice database
504 GIS Adaptation directive index
505. GIS Adaptation Graduate User
506. GIS Adaptation course screen
600. Boot camp unit interface (database)
601. Boot camp unit questionnaire
602. Boot camp unit resources
603. Boot camp unit practices database
604. Boot camp unit directive index
605. Boot camp unit Graduate User
606. Boot camp unit course screen
607. Manifesto tool
700. Infantry (master) camp unit interface (database)
701. Master camp unit questionnaire
702. Infantry (master) camp unit resources
703. Database of Infantry (master) camp unit practices
704. Infantry (master) camp unit directive index
705. Infantry (master) camp unit graduate user
706. Infantry (master) camp unit course screen
800. Project output
801. Work sets
802. Serial user (serial entrepreneur)
803. Declaration index
804. Prohibited list database
805. Graduate information database (forum)
810. Junior user
811. Master user
812. Expert user
813. Virtuoso user
814. Maestro user
900. UGGS unit interface
901. UGGS unit questionnaire
902. UGGS unit resources
903. UGGS unit practices
904. UGGS unit directive index
905. UGGS unit graduate user
906. UGGS unit course screen
910. GIA unit interface
911. GIA unit questionnaire
912. GIA unit resources
913. GIA unit practices
914. GIA directive index
915. GIA unit graduate user
916. GIA unit course screen
920. User characterized as a Gold member

The equivalents of the abbreviations used in the description are listed below.
GIS: Name given to the system consisting of the interfaces that make up the invention
GIS Adaptation: interface which is the first step of the education system
GIS Boot: interface which is the second step of the education system
GIS Infantry: interface which is the third step of the education system
GIA: special training interface that can be attended by users who have completed the three previous interfaces (i.e. all training units) and the evaluation criteria
Directive index: a set of rules to be followed in the relevant training interface
Unit: Training interface consisting of users who are entitled to participate in the relevant training interface
Life purpose interface: Final anxiety about life created by one's experience, including one's sensitivities about life
User interests: areas where the user is passionate about the purpose of life
Manifesto: Declaration on the fight against social problems that the person will focus on the business idea they create in line with their life purpose.
GIS Adaptation practices: Repetition, Extraction, Paper, Aquarium and Future Me in the interface, which is the first step of the education system
Boot camp unit practices: 100, Angle, Aquarium, Purpose, Key, Helpless, Magazine, Course, Milestone, Storm, Idea, Philosophy, Future Me, Power, Story, Manifesto, Ladder, Occupation, Curtain, Plan, Portrait, Program, Compass, Interview, Last, Inquiry, Three and Design
Infantry (master) camp unit practices: Opening, Aikido, Action, Infrastructure, But, Survey, Search, Aydos, Blog, Brief, Buddy, Finding, China, Resolving, Behavior, Debrief, Listening, Diet, DNA, Emotion, Empathy, Future Me, Rose, Trust, Memory, Dream, Divinity, Name, intelligence, Business Development, Jahori, Book, Concept, Control, Celebration, Manifesto, Space, Reconciliation, Network, Point, Online, Automation, Market, Advertising, Reset, Ritual, SAS, SELL, Zero, Verbal, Meeting, Savings, TED, Repeat, Tajuz, Meeting, International, Hope, Hypothesis, Web, False, Vow, Unbeatable Food and YouTube
Mentor support interface: Interface where expert people support users
The interface that allows making a difference: Structure that allows the participant to create a positive transformation/change that will affect the masses in the social problems that they focus on within the scope of their project in line with their life purpose
Interface that allows value creation: A value-added service/product that is produced within the scope of the participant's project in a way that will provide social benefit-oriented results
Graduated user: user who has completed the relevant interfaces
UGGS: Unit (group) of users identified as Master Entrepreneurial Initiative Fighters who have completed all training
Banned user: User who acts in a way that does not comply with the directive and declaration index
Prohibited list database: A set of information containing users who act in a way that does not comply with the directive and declaration index
Junior user: The user working in the case of an employee who has just entered the business life and has not specialized in the project output or work sets
Master user: Employee who has specialized and gained experience in a specific field in project output or work sets
Expert user: field expert user who has gained in-depth competence in the field of expertise in the project output or work sets and is responsible for the average amount of resources in the institution
Virtuoso user: field expert user responsible for medium to high amount of resources in the institution, who has the highest level of depth in their fields in the project output or work sets, who can interpret their profession, who can design new methods
Maestro user: a user who is knowledgeable in project output or work sets in many different branches other than their expertise, who is competent to ensure that people and processes work in harmony as a whole and to guide main strategies, and who is responsible for high-level resources

### DESCRIPTION OF THE INVENTION

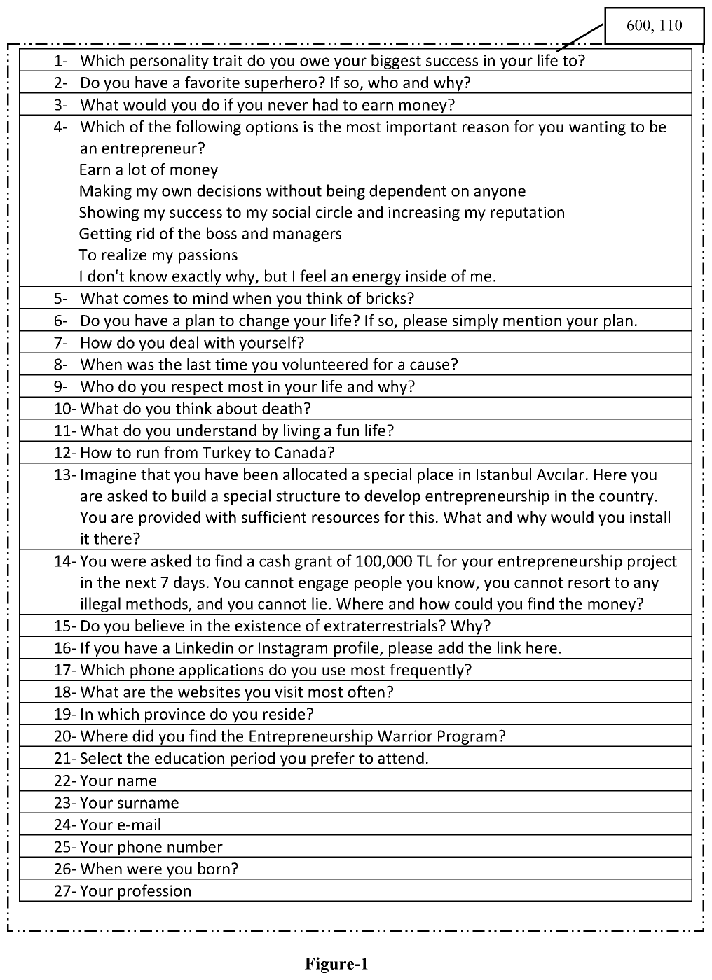

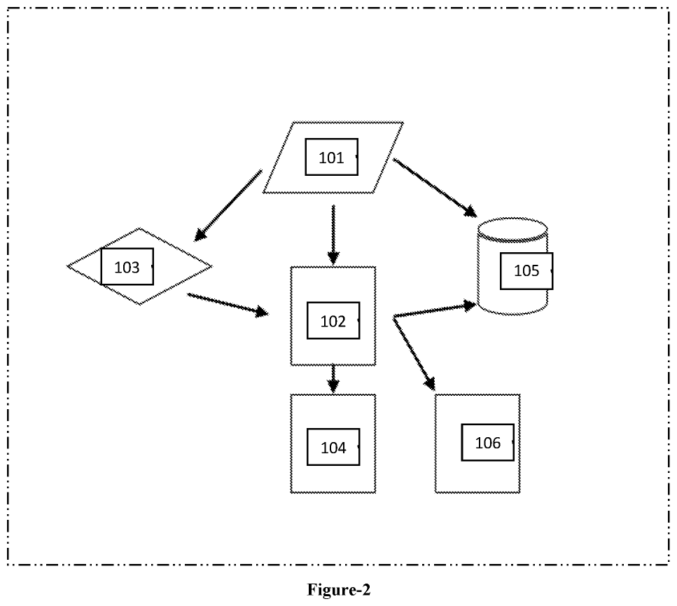

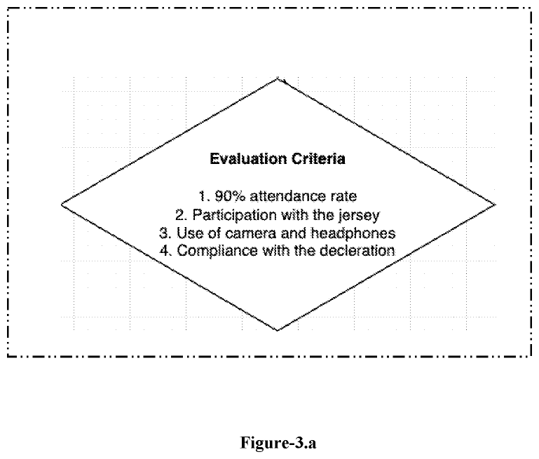

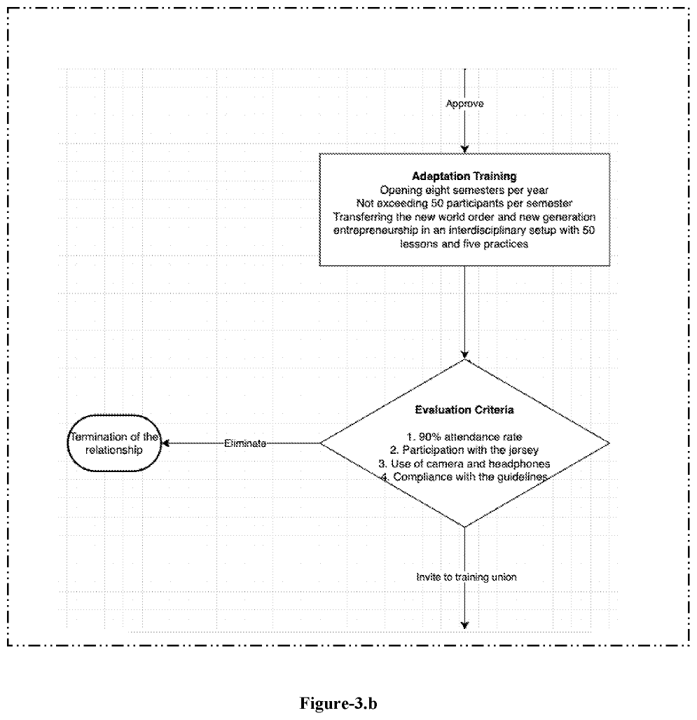

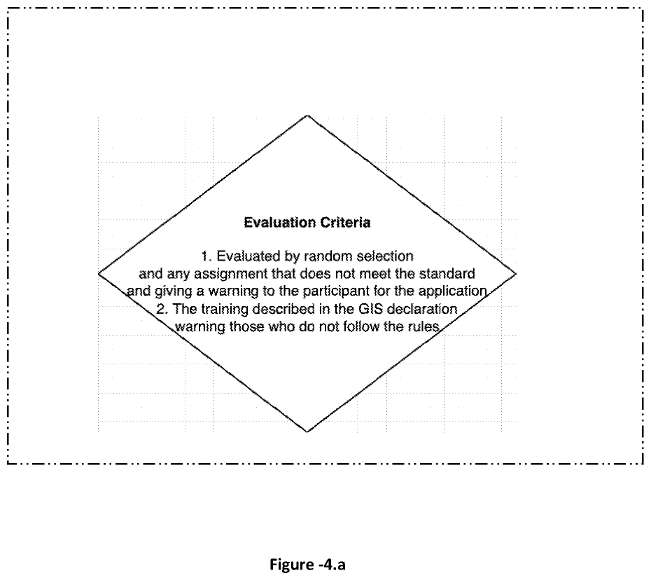

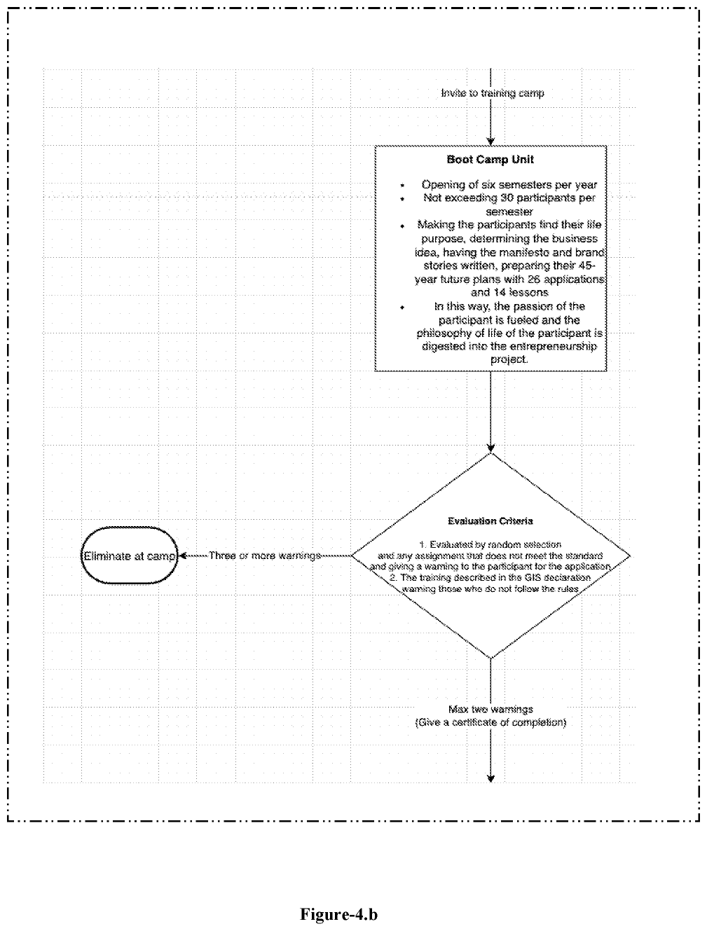

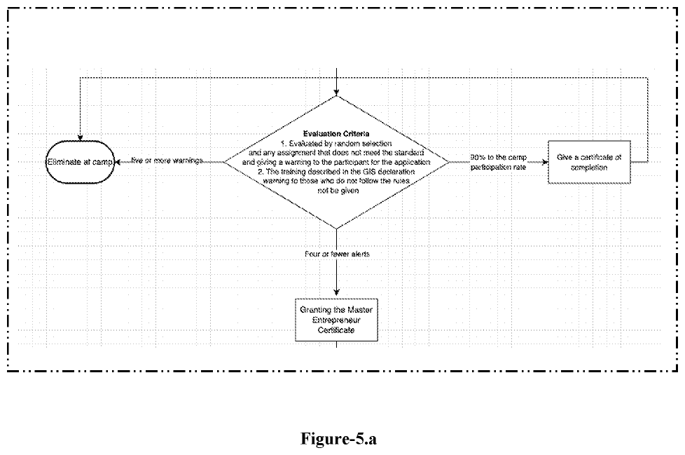

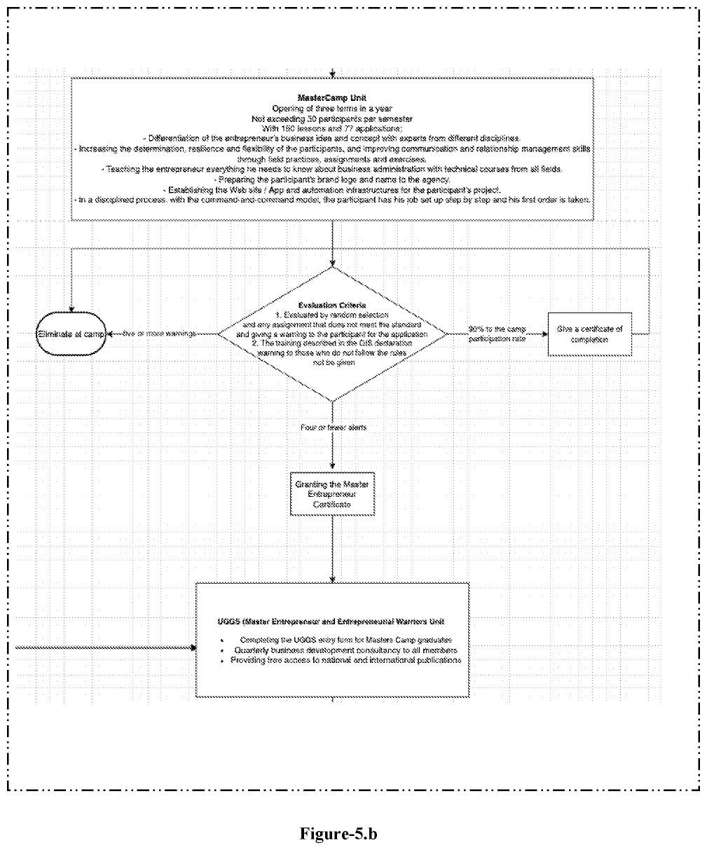

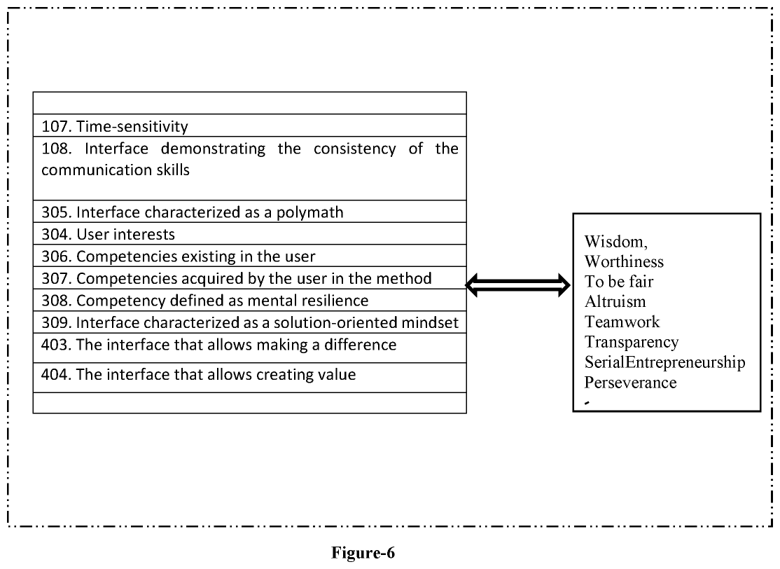

The present invention consists of a system (platform) (200) and an organization method (900, 910), whose interface with adaptation training (500), training units (600, 700) and permanent units (900, 910) are mainly three interfaces, can be developed and graduated users (706) are entitled to participate in two interfaces according to their achievements and to participate in the next training and organization database (900, 910). The said interfaces are presented to the users respectively. From the beginning, it consists of a platform (200) that supports continuous development and is organized as UGGS (900) and GIA (910) interfaces, respectively, to which users who complete the adaptation training interface (500), boot camp unit (600), Infantry (master) camp (500) and only these interfaces are entitled to participate. Users who are eliminated on one interface, respectively, are not able to continue or restart on the next other interfaces. Users consisting of the target audience (300) reach the platform (200) organically from the web interface (303). Here, there is a user information database (100) accepted by the training platform (200). The process begins when users answer the questionnaires (201) that make up the database (100) in FIG. 1. According to the answers that the users answered in the questionnaire, the artificial intelligence algorithm-based index (FIG. 2) is subject to preliminary evaluation. The algorithm index in which the said preliminary evaluation system is located is given in FIG. 2. This questionnaire is an elimination according to the evaluation system in the index. Here, the users who will be entitled to participate in the training interfaces are determined by the algorithm. Users who are entitled to participate in the interfaces continue to the adaptation interface (202). Users who are not entitled to participate in the interfaces apply again if they have not fallen into the prohibited list database (804). Users (300) who participate in the adaptation training start to progress on the training method developed with the questionnaire (501) that they find answers in the adaptation resources (502). On this interface (500), users (300) access the answers to the questions in the GIS adaptation questionnaire (501). This interface (500) consists of a multidisciplinary database and system with more than fifty course screens (506) and more than five practices. Users with the characterized interface (108) and the time-sensitive interface (107) are now defined as GIS Adaptation Graduate Users (505), as the consistency of communication skills that completed this section and adhered to the defined directive index (504). Users (adaptation graduate user) (505) who complete this interface (500) are entitled to continue to the boot camp unit interface (600).

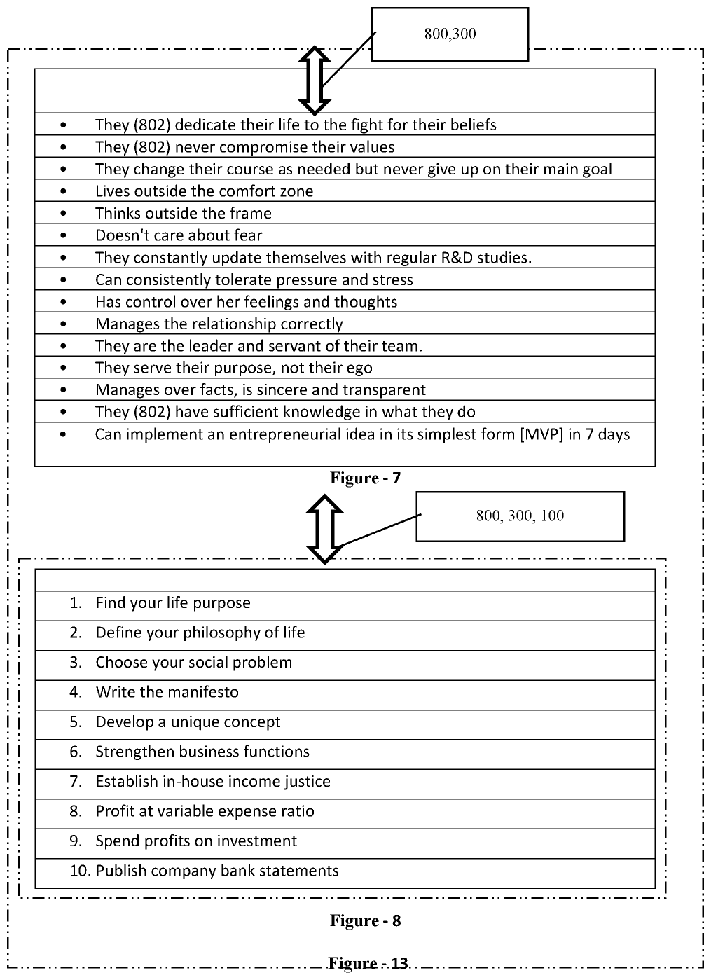

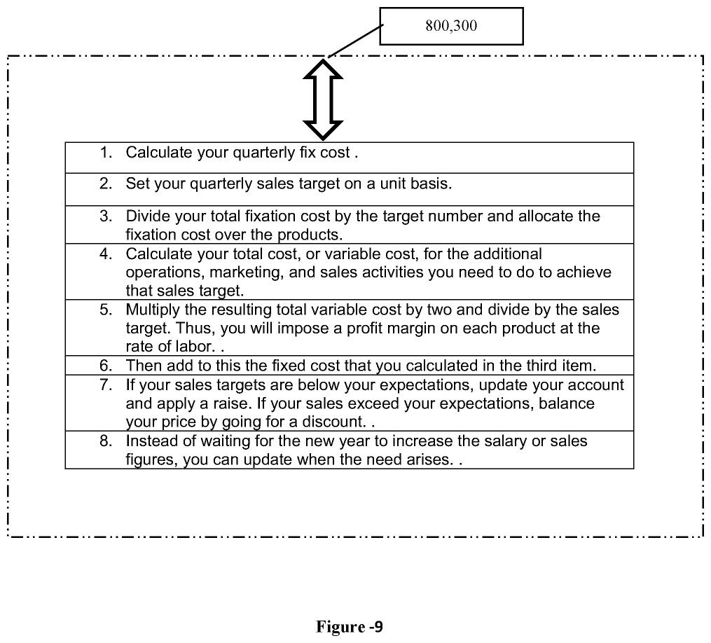

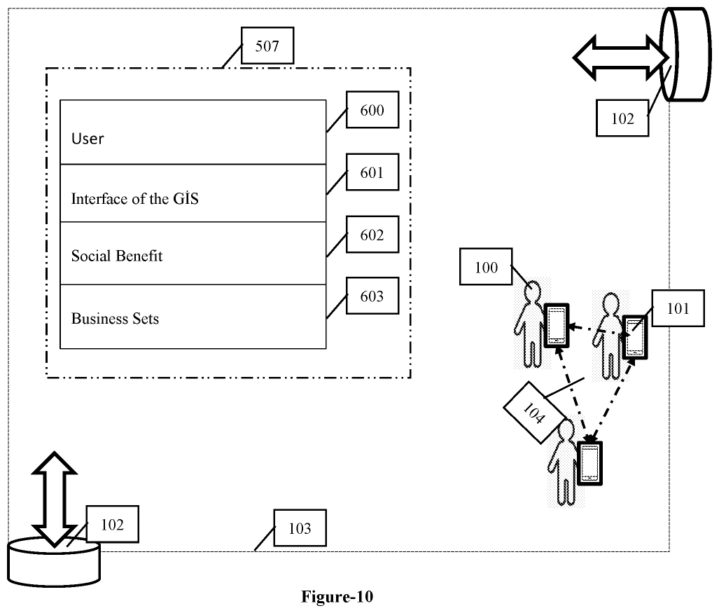

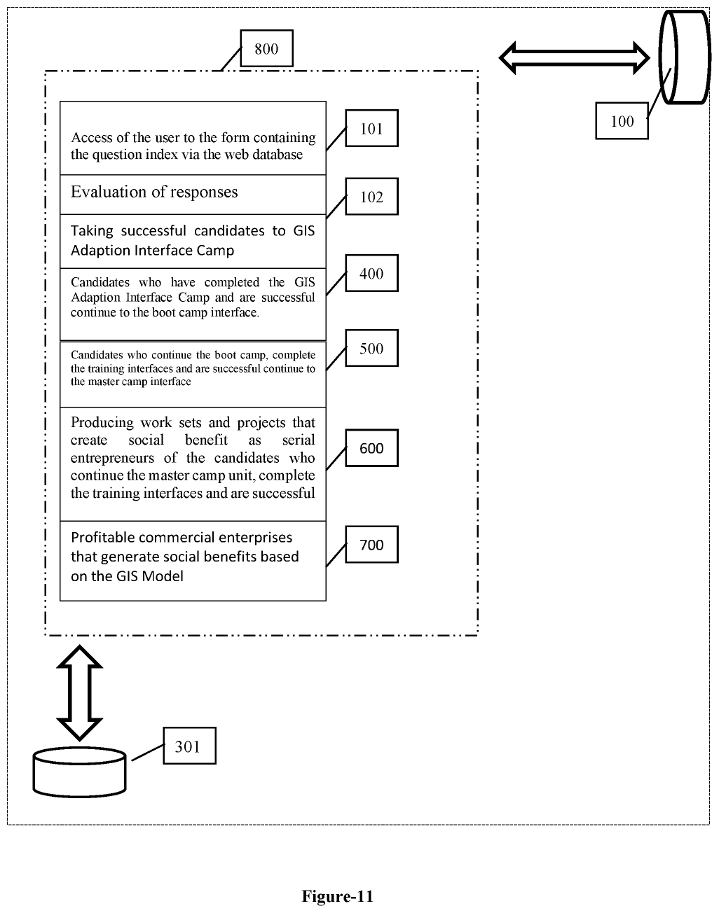

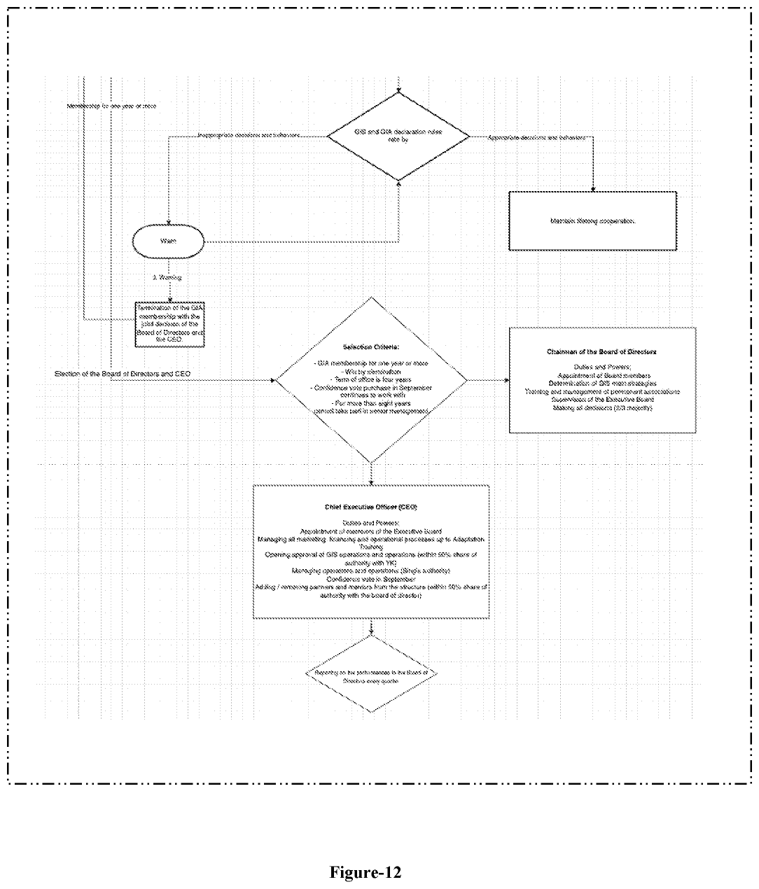

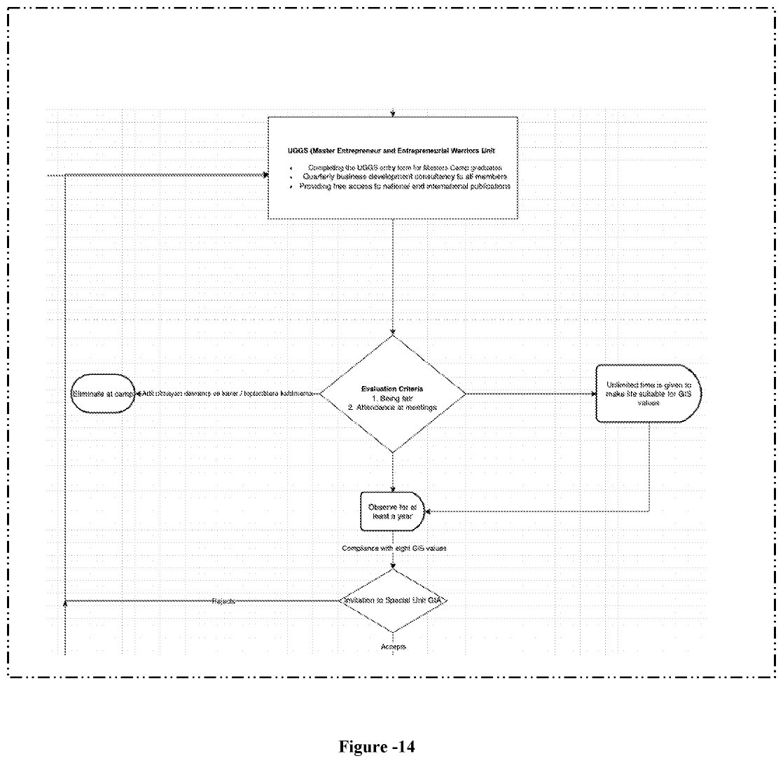

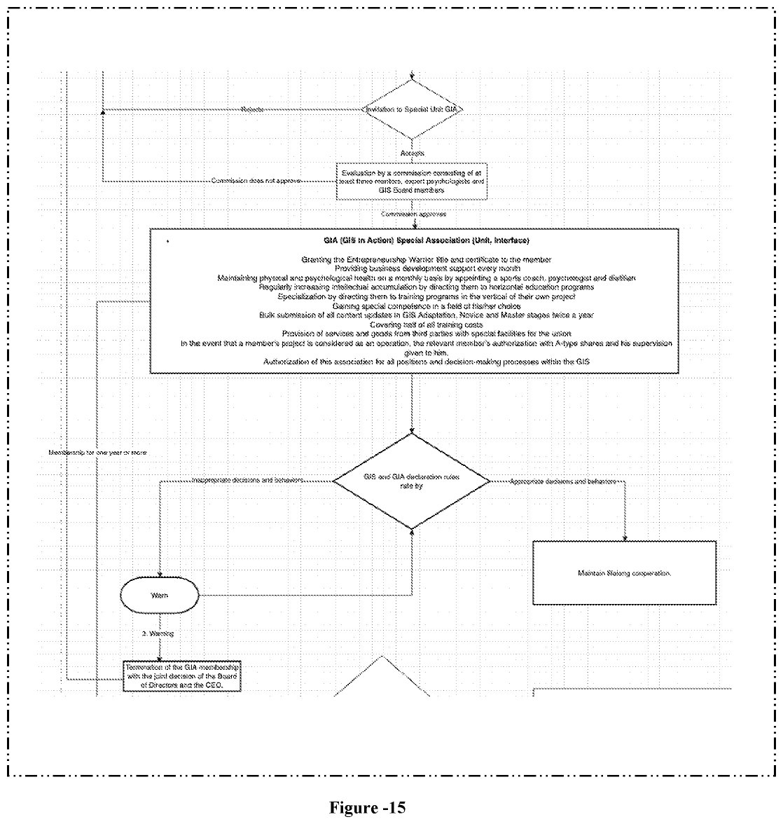

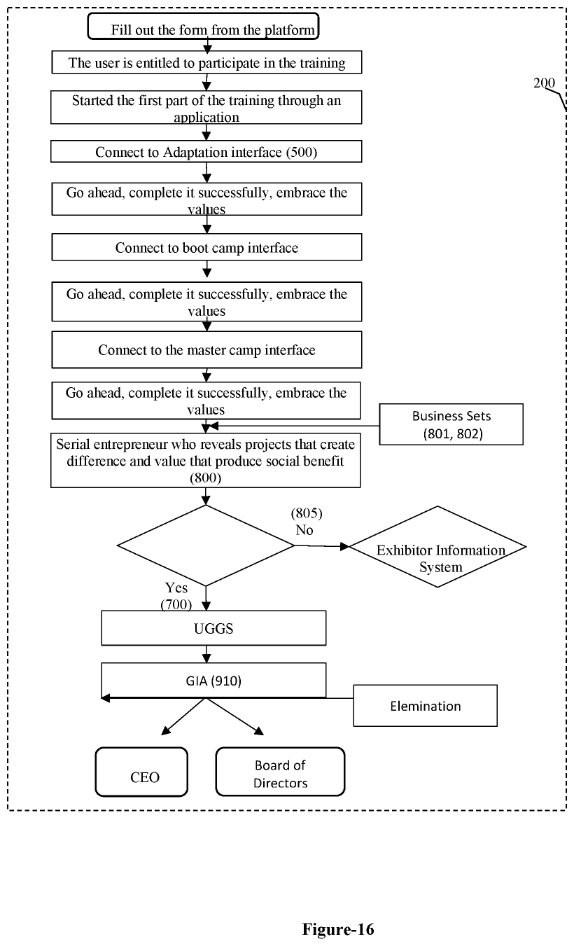

The relationship with users who are not entitled to participate in the boot camp unit interface (600) is terminated, they cannot be included in the database (100) again, and they lose the right to participate in other interfaces. Users who are entitled to participate in the boot camp unit interface (505) begin to progress on the training method developed with the directories of questionnaires (501) that they find answers to in the boot camp unit resources (502). On this interface (500), users (505) access the answers to the questions in the GIS boot camp unit questionnaire (601). This interface (500) consists of a multidisciplinary database and system with more than ten course screens (506) and more than twenty-five practices. Users (505) are included in a system that allows them to produce a commercial business idea (800, 801) suitable for the surface (database) (301) and the social problem they choose and to use the manifesto tool (607) in line with their interests (304). In this system, which is characterized as the boot camp unit interface (database), the existing competencies (306) of the user are developed and the competency interfaces (307) that the user gains as a result of the practice and resources are also revealed. With the resources (602), courses (606) and practices (603) herein, users (505), brain structure (310) and brain functioning (311) access the repositories of information and prepare the ground for the profile (FIG. 7) characterized as serial users. Users who complete this section and comply with the defined instruction index (604) are now defined as GIS Boot Camp Unit Graduate Users (605). Users (GIS Boot Camp Unit Graduated User) (605) who complete this interface (605) are entitled to continue to the Infantry (master) camp unit interface (700).

The relationship with users who are not entitled to participate in the Infantry (master) camp unit interface (700) is terminated, they cannot be included in the database (100) again, and they lose the right to participate in other interfaces. Users who are entitled to participate in the Infantry (master) camp unit interface (605) start to progress on the training method developed with the questionnaires (701) that they found answers in the Infantry (master) camp unit resources (702). On this interface (700), users (605) have access to the answer to the questions in the GIS Infantry (master) Camp Unit interface questionnaire (701). This interface (500) consists of a multidisciplinary database and system with more than one hundred and fifty course screens (706) and more than eighty practices (703). Users (605) are involved in a system that allows them to develop the business idea (314) suitable for the life purpose interface (database) (301) in line with their interests (304), and that allows creative project output (800) and work sets (801) to be formed with the help of the expert mentor support interface (302) having different disciplines in this direction.

In this system, which is characterized as the Infantry (master) camp unit interface (database), although the existing competencies (306) are developed in the user, the competence interfaces (307) that the user gains as a result of the practice and resources are also revealed, and the interface (305), which is characterized as a polymath, the interface (309), which is characterized as a solution-oriented thinking structure, and the competencies interface (308), which is defined as mental resilience, is highly developed. With the resources (702), courses (705) and practices (703) contained herein, users (605) access the repositories and prepare the ground for the profile (FIG. 7) characterized as serial users.

Users who complete this section and comply with the defined instruction index (704) are now defined as GIS Infantry (master) Camp Unit Graduate Users (705). Users (GIS Infantry (master) Camp Unit Graduated User) (705) who complete this interface (705) are entitled to continue to the UGGS unit interface (900).

Users who are not eligible to participate in the UGGS unit interface (900) are registered in the graduate information database (forum) (805). They cannot be included in the database (100) from the beginning for interfaces they have received up to this section, they lose the right to participate in other subsequent interfaces.

Users (705) who are entitled to participate in the UGGS unit interface (900) start to progress on the training method developed with the questionnaire (901) that they find answers in the UGGS unit resources (902). On this interface (900), users (705) have access to the answer to the questions in the UGGS unit questionnaire (901). This interface (900) consists of a multidisciplinary database and system in which users periodically benefit from the mentor support interface and have access to resources (902).

Users (805) are involved in a system that allows them to generate a business idea (314) suitable for the life purpose interface (database) (301) in line with their interests (304), and to use information support interfaces where they can receive lifelong support in this direction without any time limit. Users (905) who continuously adapt to the user model (FIG. 8), which is characterized as a GIS type in this section, are invited to the GIA Special Unit (910) with a special invitation when they adapt to the values in FIG. 8.

Users (905) who are entitled to participate in the GIA Special Unit (910) start to progress on the training method and other developments developed with the questionnaire (901) that they found answers in the resources of the UGGS unit (902). On this interface (910), users (905) have access to the answers to the questions in the UGGS unit questionnaire (911). This interface (910) consists of a multidisciplinary database and system in which users benefit from the mentor support interface without restriction at certain periods, interfaces and databases that allow them to gain competence in a specific field of their choice are presented and resources (912) are accessed without restriction. Users who comply with the directive index (614) and declaration index (803) defined in the GIA unit are serial users (802), but they are now entitled to become users (920), who are characterized as Gold members with the highest powers and characteristics.

In this interface (910), the collaboration continues without time constraints on communication, resources, practices, information database and platform. It makes use of all the support interfaces mentioned in this interface. Users who qualify for the GIA Special Unit (905) progress with the continuously improved methods with the questionnaires (711) that they find answers in the GIA unit resources (912).

Among the users who are entitled to the GIA Special Unit (905), those who comply with the instructions and declarations are referred to as users (920), who are characterized as gold members and are at a higher level.

The user (920), who is characterized as a Gold member, is referred to as the user who intersects the purpose of life with social problems and gains by combining it with profit, thus contributing the most to the training and organization of visionary, vigorous and sensitive entrepreneurs who can both realize their life philosophy and establish companies that can sustainably combat social problems.

One of the methods created in accordance with the system constituting the present invention is to determine the sales price of the product produced as a result of the work set or project output. A fair product sales calculation method has been established in the enterprises where the work set and projects that generate commercial profit turn into output, respectively;

Sales Price Calculation Formula: [(Fixed Cost/Sales Quantity Objective)+(Variable Cost×2)/Sales Quantity Objective]=Sales Price of the Product

Calculating the quarterly fixed cost, determining your quarterly sales target on a unit basis, dividing the total fixed cost by the targeted sales product quantity and distributing the fixed cost on the products, calculating the total variable cost for the additional operations, marketing and sales activities required for the said sales target, multiplying the resulting total variable cost by two and dividing it by the sales target. Thus, adding a profit margin at the rate of labor on each product, then adding a fixed cost, implementing the sales targets, applying an increase by updating the account if it is below the expectation, balancing the price by going to the discount if the sales exceed the expectation, updating when needed instead of waiting for the new year to increase the salary or sales figures, proving to the international community that the company is fighting for a social benefit by making its bank statements and finances public.

1. The present invention is related to a controlled system that supports different thinking skills of the user (300) with a multi-disciplinary resource (402, 502, 602, 702), equipment, and applications (403, 503, 603, 703), enables their competences (306) to come out in accordance with the field of interests (304), allows them to detect the life purpose interface (301), allows said interface (301) to coincide with social problems (400), allows them to gain by combining with commercial benefit (profit) (401), produces compositions depending on the content (402) created by the inventor, and depending on them, enables the user to think as a polymath according to the new world order, analyze, take action and through new interfaces (400, 500, 600, 700) improve projects (800) or work sets (801) which create difference and value, as well as an organization method developed according to said system; characterized in that it consists of a system
Which consists of training and unit interfaces that are improvable and organizable such as proficiency adaptation interface unit (500), boot camp unit (600), master camp unit (700), and permanent unit where users can progress gradually,
Which enables, in the interfaces, the users that conform to question index and instructions in accordance with related interfaces to graduate and be entitled to join subsequent training interfaces,
Which develops solution-oriented methods that are consisted of a multi-disciplinary structure where a plurality of training and applications are available in the interfaces,
Wherein there are courses screens over fifty and applications over five in the proficiency interface, courses screens over a hundred and applications over twenty-five in the recruit interface, course screens over a hundred and fifty and applications over eighty in the expert interface,
Which facilitates to improve the existing talents of the users and to access the information repository by means of these applications and course screens available in the interfaces,
Which allows the user to generate business project output (800) and business sets (801) that develop solution-oriented methods from the multi-disciplinary resources (300) by presenting mentoring support interface which is expert in the related field,
Which enables the user to gain wide perspective (900), acquire different thinking skills (305), and level up their intellectuals with the developed interdisciplinary training model,
Wherein the users that are graduated from all of the interfaces are invited to special units where they can get lifetime support and subsequently, may have the highest authority, privileges, and characteristics within the organization.

2. Claim 2 is a system according to claim 1, wherein the interfaces (400, 500, 600, 700) that allow the users to know the brain structure (310), working of the brain, and thinking modes (311), to improve the thinking structure and to overcome inertia exist at the same time.

3. Claim 3 is a system according to claim 1 or 2, wherein the users that are not graduated from interfaces are prevented from proceeding to other subsequent interfaces or starting over, wherein only the successful users are allowed to proceed.

4. A system according to any of the preceding claims, which aims to improve the user's life quality (312) by enhancing the user's productivity through the training related to the interfaces (400, 500, 600, 700) which approaches military order system and which are based on dietary habits that affect the user's life order directly in some of the applications comprised as well as to more effective projects to come out.

5. The present invention is a system consisting of interfaces according to any of the preceding claims, which aims to improve a method that allows the users (100) to have more mental resilience (307, 308) and to improve characteristics such as wisdom (307, 308), merit (307, 308), fairness (307, 308), altruism (307, 308), teamwork (307, 308), transparency (307, 308), mental (307, 308), and physical resilience (307, 308), entrepreneurship, serial entrepreneurship (802), solution-oriented thinking in terms of social problems (309) and to be disciplined.

6. A system according to any of the preceding claims, wherein the sale price of a product produced as a result of the business set or project output is determined by a fair product sales calculation method in businesses where business sets and projects that provide commercial profit turn into output and calculated by the following formula,
Sale Price of the Product=[(Fixed Cost/Number of Sales Target)+(Variable Cost×2)/Number of Sales Target]
